(19) United States
(12) Patent Application Publication
(10) Pub. No.: US 2026/0340451 A1
(43) Pub. Date: Oct. 29, 2026

(54) MANAGING MECHANISMS IN GENERATIVE ARTIFICIAL INTELLIGENCE (AI) PIPELINES

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,549

(22) Filed: Apr. 28, 2025

(51) Int. Cl. G06N 5/04

(52) U.S. Cl. CPC G06N 5/04

(57) ABSTRACT

Methods and systems for providing computer-implemented services using generative AI models are provided. To do so, a request may be obtained to remove information content from a portion of a prompt for a generative AI model. A first mechanism in a generative AI pipeline for the generative AI model may be temporarily paused, the first mechanism being adapted to effectively implement a decay counter for portions of the prompt. While the first mechanism is paused, an un-inferencing process may be performed to obtain an updated generative AI pipeline, the updated generative AI pipeline being less impacted by the portion of the prompt than the generative AI pipeline. The operation of the first mechanism may be resumed and the updated generative AI pipeline may be used to obtain a response to the prompt. Computer-implemented services may be provided using the response.

### FIELD

Embodiments disclosed herein relate generally to providing computer-implemented services using generative artificial intelligence (AI) models. More particularly, embodiments disclosed herein relate to managing mechanisms in generative AI pipelines.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show flow diagrams illustrating data flows in accordance with an embodiment.

FIGS. 2D-2G show an example graphical user interface (GUI) and an example generative AI session in accordance with an embodiment.

FIGS. 3A-3B show flow diagrams illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with prompts. The outputs may be used, at least in part, to provide the computer-implemented services. For example, the outputs may be provided to a downstream consumer and the downstream consumer may use the outputs to make decisions.

The outputs may be provided to downstream consumers as part of generative AI sessions (e.g., chat sessions) with the downstream consumers. A generative AI session may include any exchange of prompts from a first entity (e.g., a downstream consumer) and outputs from a second entity (e.g., a generative AI model). For example, a chat session may be initiated by a downstream consumer (e.g., a client, a customer) via a graphical user interface (GUI). The customer may enter a prompt, which may be displayed in a chat window of the GUI. The prompt may be used as ingest for a generative AI model and the output generated by the generative AI model may be added to the chat window as a response from a chat agent (e.g., a virtual assistant). The downstream consumer may enter additional prompts during the chat session and all prompts and outputs may be recorded on the chat window during the chat session.

However, generative AI models may generate new outputs based on all components of the chat history (e.g., all prompts and outputs during the chat session). Therefore, if a downstream consumer mistakenly enters some information as a prompt or decides that a previously entered prompt is no longer desired to be used as part of the chat session (e.g., due to eliciting an unwanted response), the downstream consumer may have to begin a new chat session and/or may receive outputs during the chat session that do not meet needs of the downstream consumer (e.g., may be inaccurate, may be irrelevant).

To improve a user's (e.g., a downstream consumer's) experience and increase a likelihood of providing outputs that meet expectations of the downstream consumer, the user may request, via an interaction with the GUI, that information content be removed from a generative AI session history of the chat session. The generative AI session history may include all prompts provided by the user during the chat session, all outputs provided to the user during the chat session, internal analysis information used by the generative AI model while generating outputs (e.g., information not provided to the user via the GUI), and/or other information related to the chat session. The generative AI model may be temporarily modified to obtain a temporarily updated generative AI model so that outputs generated by the temporarily updated generative AI model may be less influenced by the information content for the duration of the chat session.

Temporarily modifying the generative AI model may include: (i) adding a negating layer to the input layer of the generative AI model, (ii) adding a negating layer to a layer that feeds into an attention layer and/or a hidden layer of the attention layer, (iii) modifying (e.g., zero masking) embeddings corresponding to the information content that is requested to be removed, and/or (iv) other methods.

An output may, therefore, be generated by the temporarily updated generative AI model based on the generative AI session history. The output may be used to provide computer-implemented services to the user (e.g., the output may be added to the chat window).

At the conclusion of the chat session, the temporarily updated generative AI model may be reverted to the generative AI model (e.g., any temporary modifications to an internal state of the generative AI model may be reversed). Consequently, the request to remove the information content may not impact future chat sessions that the generative AI model participates in.

Thus, embodiments disclosed herein may provide an improved method for providing computer-implemented services using generative AI models. To provide the computer-implemented services as desired by downstream consumers, information content may be removable from a current chat session thereby allowing the chat session to continue without an impact of the removed information content. Doing so may increase a likelihood that outputs generated as part of the chat session are accurate and relevant to the needs of the downstream consumer. In addition, time resources for the downstream consumer may be conserved by reducing a need to begin new chat sessions when undesired information content is introduced.

In an embodiment, a method for providing computer-implemented services using generative AI models is provided. The method may include: making an identification that a portion of a prompt for a generative AI model of the generative AI models has been requested to be removed; based on the identification: temporarily modifying operation of a first mechanism in a generative AI pipeline for the generative AI model to reduce an impact of the first mechanism and to obtain a first updated generative AI pipeline, the first mechanism being adapted to effectively implement a decay counter for portions of the prompt; performing, while the first mechanism is temporarily modified, an un-inferencing process for the generative AI model to obtain a second updated generative AI pipeline, the second updated generative AI pipeline being less impacted by the portion of the prompt than the first generative AI pipeline; reversing the temporary modification to the operation of the first mechanism to obtain a third updated generative AI pipeline; using the third updated generative AI pipeline to generate a response to the prompt; and providing the computer-implemented services using the response.

The decay counter may define, at least in part, how different portions of the prompt are to be used in interpreting the different portions of the prompt.

The decay counter may indicate levels of importance of the different portions of the prompt in interpreting each of the portions of the prompt.

The levels of importance may be based on temporal relations between the different portions of the prompt and each of the portions of the prompt.

Temporarily modifying the operation of the first mechanism may include pausing the decay counter so that weights of an attention mechanism of the first updated generative AI pipeline decay less during performing the un-inferencing process.

Reversing the temporary modification to the operation of the first mechanism may include resuming the decay counter.

The generative AI pipeline may include an inferencing engine based on the generative AI model, and the first mechanism.

Performing the un-inferencing process may include at least one action selected from a list of actions consisting of: negating embeddings corresponding to the portion of the prompt to obtain the second updated generative AI pipeline; adding a negation layer to an input layer of the generative AI model to obtain the second updated generative AI pipeline; adding the negation layer prior to an attention module of the generative AI model to obtain the second updated generative AI pipeline; and adding the negation layer to a hidden layer of the attention module to obtain the second updated generative AI pipeline.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

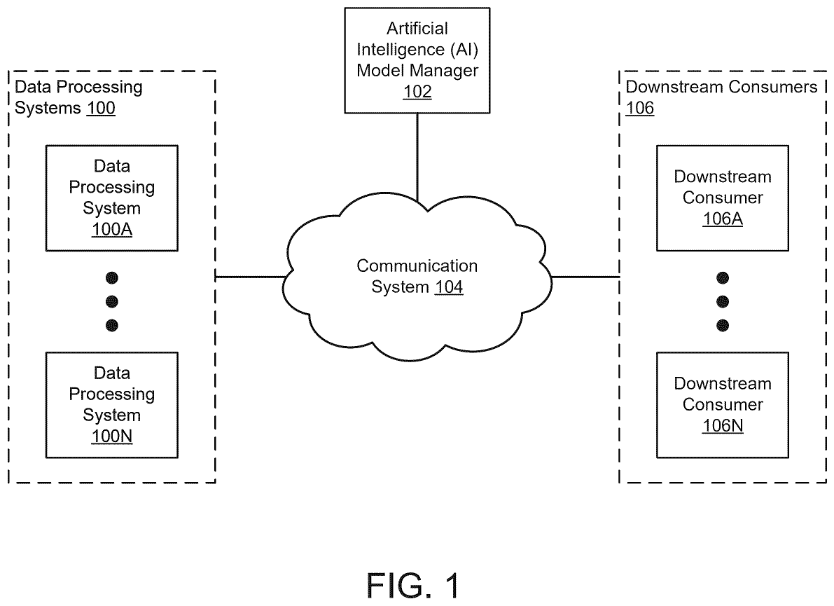

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

The outputs may be provided to downstream consumers 106 as part of generative AI sessions (e.g., chat sessions) with downstream consumers 106. A chat session may include, for example, a real-time interaction between two entities (e.g., a downstream consumer and an AI agent) during which information is exchanged. The information may include prompts provided by the downstream consumer and outputs generated by a generative AI model. The prompts and the outputs may include any type of data modality (e.g., images, audio, video, text).

A chat session may be accessed by a downstream consumer (e.g., 106A) via a graphical user interface (GUI) used as part of, for example, a customer support service, a data analysis service, a content creation service, and/or other services. Downstream consumer 106A may provide a prompt and the AI agent may provide an output that is responsive to the prompt. The AI agent may include a software program that manages, at least in part, operation of the generative AI model and that serves as a proxy for the generative AI model in a simulated conversation with the downstream consumer during the chat session. The generative AI model may use all previous prompts and all previously generated outputs to generate each additional output as part of the chat session.

However, downstream consumer 106A may provide information content via a prompt that is: (i) erroneous, (ii) irrelevant, and/or (iii) otherwise not desired to be used during a remainder of the chat session. In addition, a prompt may elicit an unwanted response (e.g., a generative AI model output that does not meet expectations of downstream consumer 106A). As the information content may impact the remainder of the chat session, outputs generated by the generative AI model during the chat session may no longer meet expectations of downstream consumer 106A (e.g., may include inaccurate and/or irrelevant information). In addition, downstream consumer 106A may need to end the chat session and begin a new chat session with the AI agent to remove an impact of the undesired information content thereby incurring a cost of time resources for downstream consumer 106A that may be undesirable.

In general, embodiments disclosed herein may provide methods, systems, and/or devices for temporarily modifying a generative AI model instance for a duration of a chat session based on feedback from a downstream consumer. The feedback may include a request for removal of information content from a generative AI session history (e.g., prompts provided by the downstream consumer during the chat session, outputs generated by the generative AI model based on the prompts, contextual data and/or internal analysis data used by the generative AI model).

The chat session may be displayed to the downstream consumer via a GUI and the downstream consumer may interact with the GUI to select portions of the generative AI session history that are desired to be removed.

Temporarily modifying the generative AI model instance may include: (i) negating, based on the request, embeddings corresponding to the information content requested to be removed from the generative AI session history, (ii) adding, based on the request, a negation layer to the generative AI model instance, (iii) adding, based on the request, a negation layer that feeds into an attention module of the generative AI model instance, (iv) adding, based on the request, a negation layer to a hidden layer of an attention module of the generative AI model instance, and/or (v) other methods.

A temporarily updated generative AI model (e.g., a modified instance of the generative AI model) may be obtained and used to generate an output based on the generative AI session history. The output may be added to a record of the generative AI session displayed to the downstream consumer via the GUI.

At a conclusion of the chat session, the temporary modifications to the generative AI model instance may be reversed (e.g., a “memory wipe” may be performed for the generative AI model to remove temporarily added information such as zero masks) so that future chat sessions may not be impacted by the temporary modifications.

Thus, embodiments disclosed herein may improve processes of providing outputs generated by generative AI models to downstream consumers of the outputs. By negating an impact of portions of a generative AI session history for a generative AI model, outputs may be generated with reduced impact of selected portions of the generative AI session history. Consequently, a likelihood of providing desired computer-implemented services while conserving time resources may be increased.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from clients, from owners of downstream consumer 106A, from employees of a company that owns downstream consumer 106A) to data processing system 100A as part of the subscribed services.

As part of providing the computer-implemented services, data processing systems 100 may: (i) obtain prompts for generative AI models (e.g., hosted and/or operated by data processing systems 100), (ii) feed the prompts into a generative AI model to obtain outputs, and (iii) provide the outputs to downstream consumers as part of providing computer-implemented services to the downstream consumers.

Data processing systems 100 may provide chat session services to downstream consumers 106. For example, one or more of data processing systems 100 may host AI agents that manage chat sessions with users (e.g., downstream consumers). A record of the chat sessions may be displayed, via the GUI, on a user's device (e.g., one or more of downstream consumers 106).

As part of providing the computer-implemented services, data processing systems 100 may also: (i) obtain, from downstream consumer 106A, a request to remove information content from a generative AI session history for a generative AI model, (ii) temporarily modify, based on the request, the generative AI model to obtain a temporarily updated generative AI model so that outputs generated by the temporarily updated generative AI model are less influenced by the information content, (iii) obtain, from the temporarily updated generative AI model and based on the generative AI session history, an output, (iv) provide computer-implemented services to the downstream consumer using at least the output, and/or (v) perform other actions.

At the conclusion of the chat session, data processing systems 100 may revert the temporarily updated generative AI model to the generative AI model (e.g., internal modifications such as zero masks may be removed) so that future chat sessions may not be impacted by the modifications to the generative AI model.

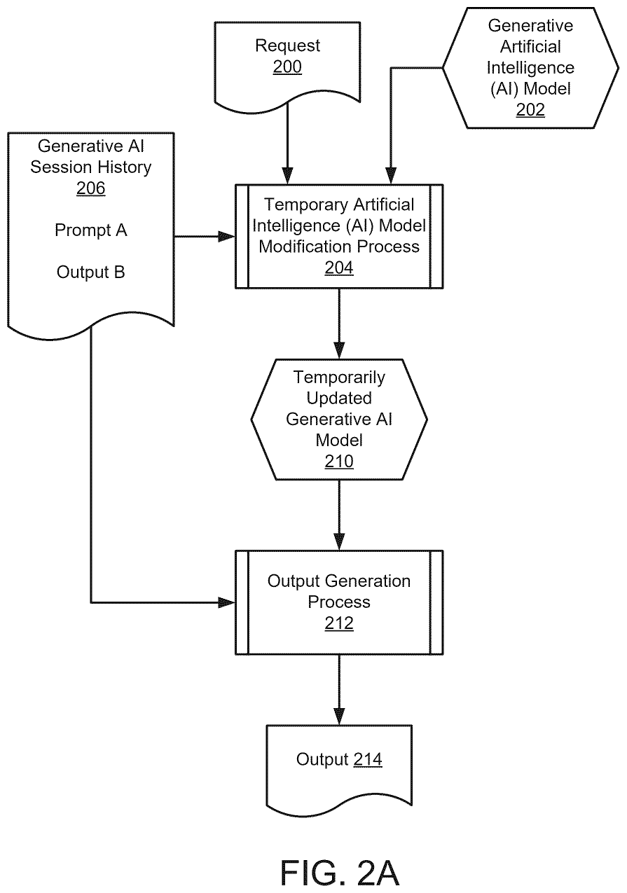

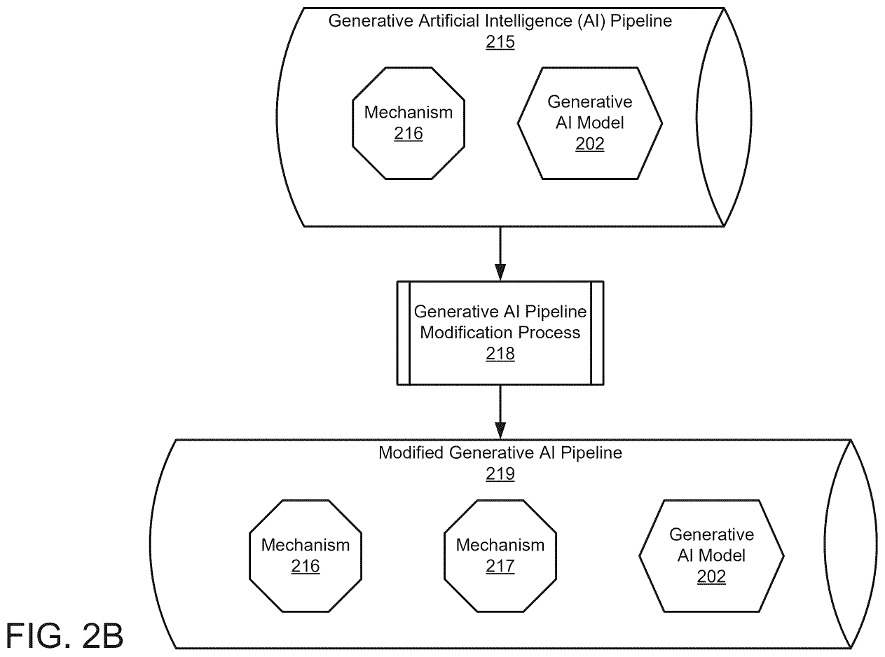

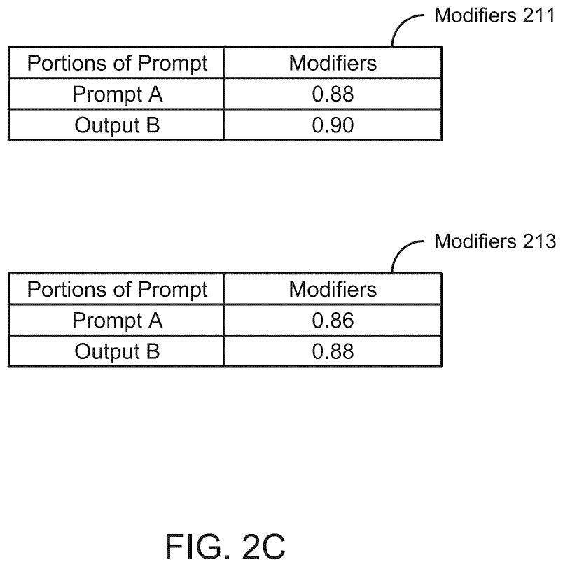

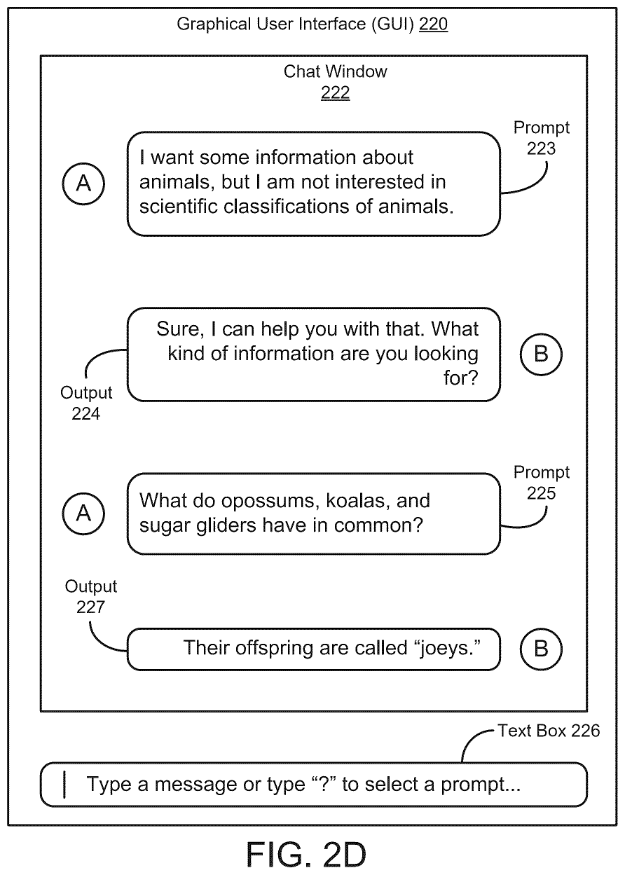

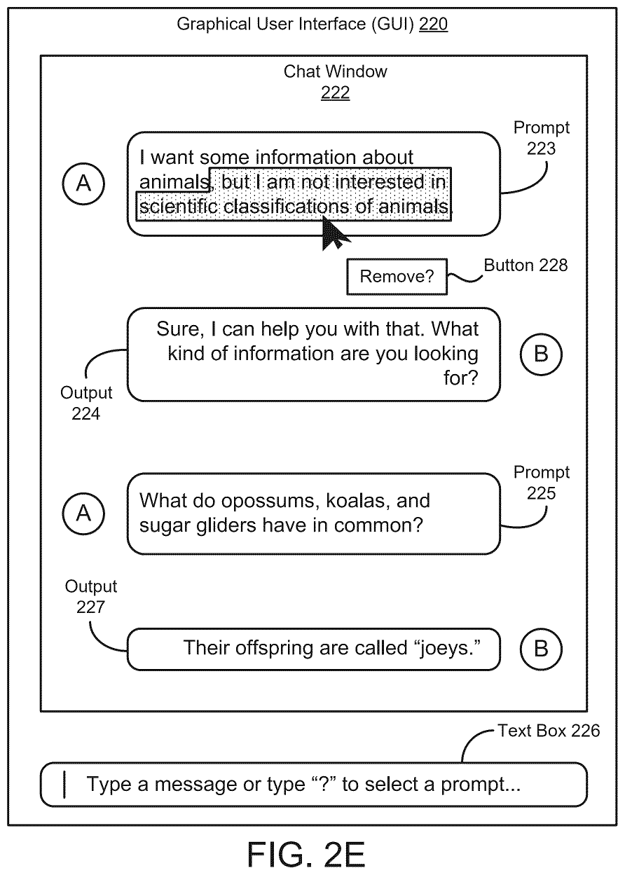

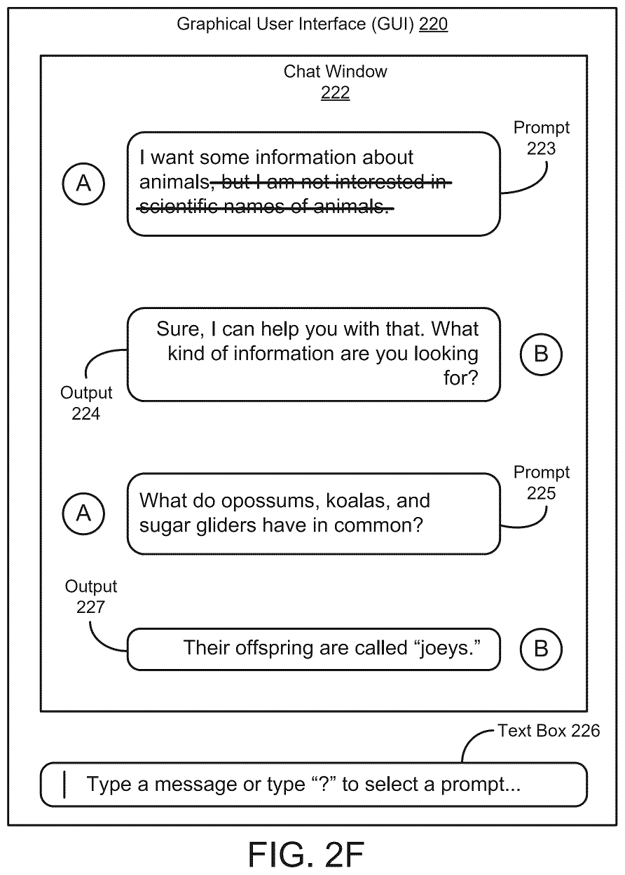

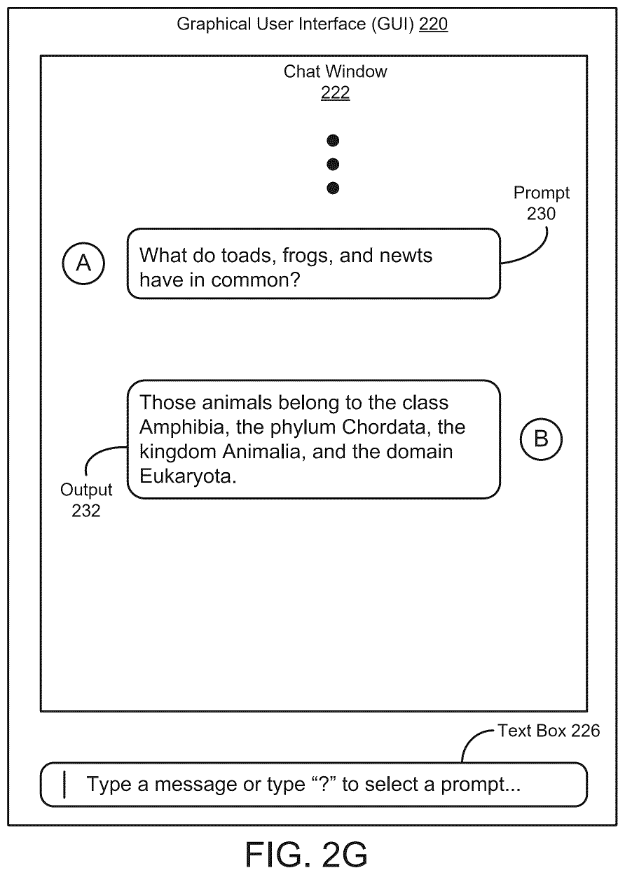

Refer to FIG. 2A for additional details regarding temporarily modifying the generative AI model. Refer to FIGS. 2D-2G for an example of a chat session during which information content of a portion of the generative AI session history is removed.

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs as part of receiving the computer-implemented services.

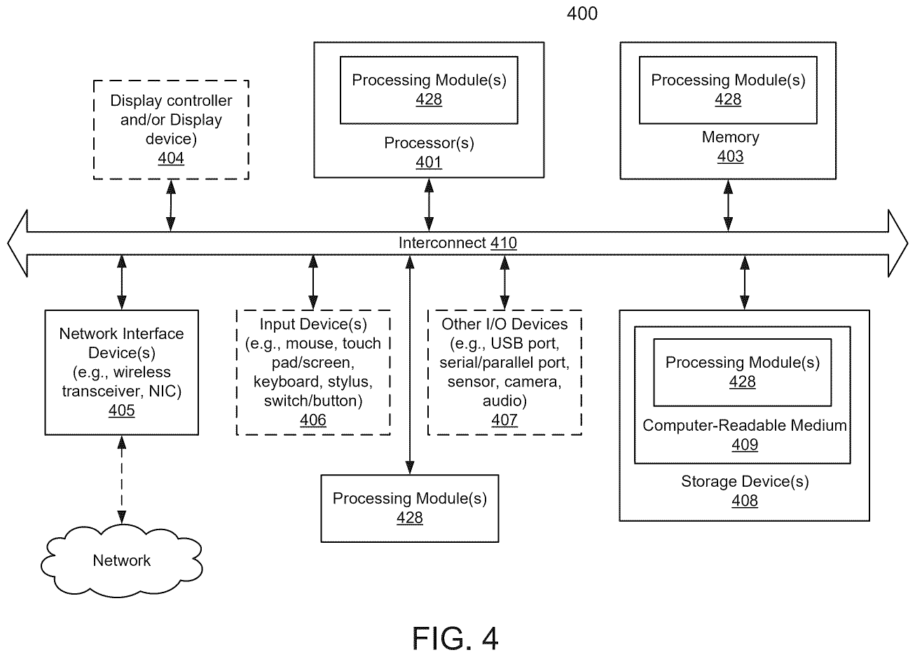

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

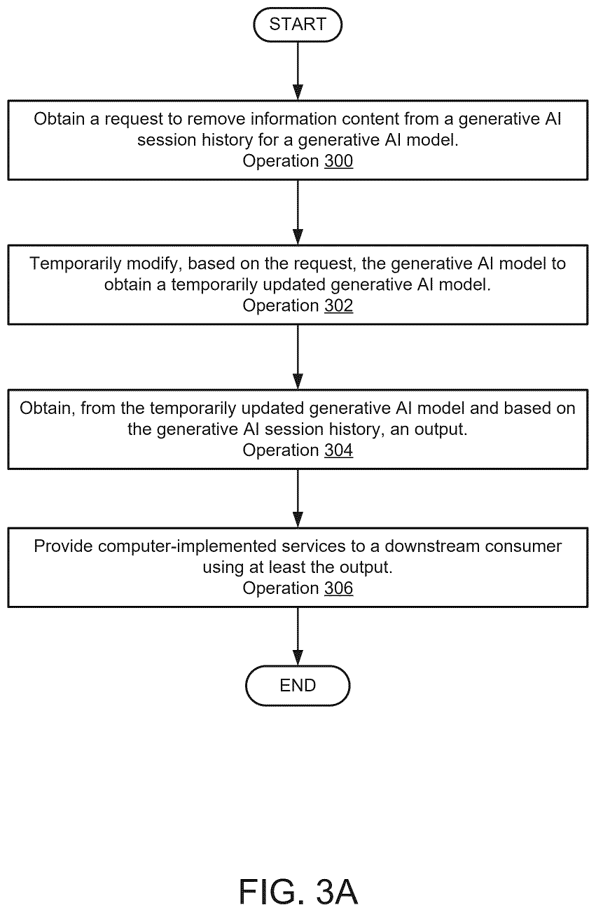

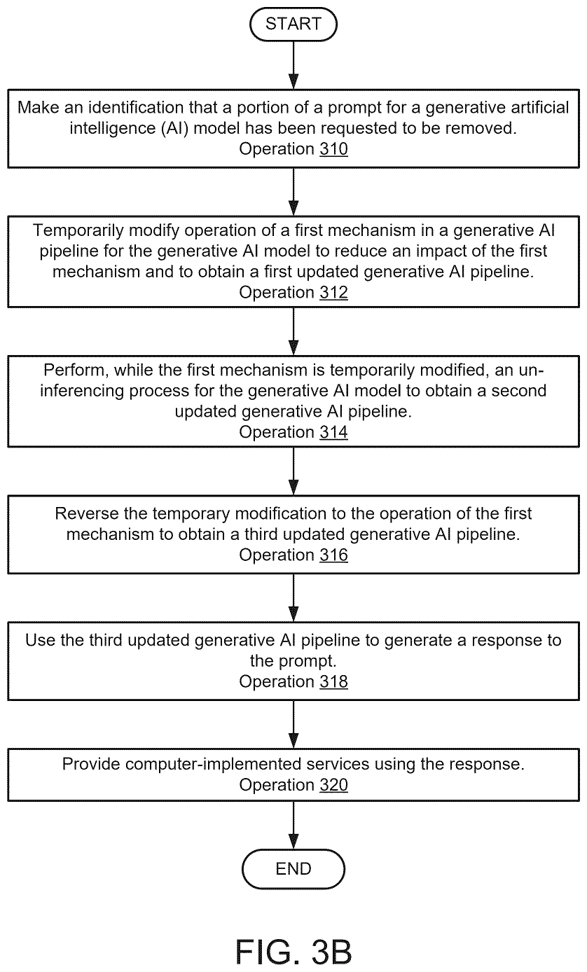

While providing their functionality, any of data processing systems 100, AI model manager 102, and/or downstream consumers 106 may provide all or a portion of the methods shown in FIGS. 2A-3B.

To further clarify embodiments disclosed herein, a data flow diagram in accordance with an embodiment is shown in FIG. 2A. In this diagram, flows of data and processing of data are illustrated using different sets of shapes. A first set of shapes (e.g., 200, 206, etc.) is used to represent data structures, a second set of shapes (e.g., 204, 212 etc.) is used to represent processes performed using and/or that generate data, a third set of shapes (e.g., 202) is used to represent generative AI models and/or other types of models, a fourth set of shapes (e.g., 215, 219) is used to represent generative AI pipelines, and a fifth set of shapes (e.g., 216, 217) is used to represent mechanisms of generative AI pipelines.

Turning to FIG. 2A, a first data flow diagram in accordance with an embodiment is shown. The first data flow diagram may illustrate data used in and data processing performed in providing computer-implemented services using at least an output generated by a temporarily updated generative AI model.

As part of providing the computer-implemented services, a downstream consumer (e.g., 106A) may initiate a chat session (e.g., with an AI agent hosted by one or more of data processing systems 100). During the chat session, the downstream consumer may provide prompts and the AI agent may provide responses (e.g., outputs generated by a generative AI model based on the prompts). During the chat session, the downstream consumer may select information content to be removed from the generative AI session history (e.g., including prompts provided during the chat session).

Request 200 may be obtained from the downstream consumer and may include an indication of the information content that is requested to be removed from generative AI session history 206. Generative AI session history 206 may include: (i) prompt A, and (ii) output B. Prompt A may have been provided by the downstream consumer during the chat session and may have been used to generate output B (e.g., by the generative AI model).

Request 200 may be provided, by the downstream consumer, via an interaction with a graphical user interface (GUI) (not shown, refer to FIGS. 2D-2G for an example GUI). The GUI may display, to the downstream consumer, a record of the chat session that includes generative AI session history 206. The GUI may also include functionality for the downstream consumer to select (e.g., using human interface devices such as a mouse and a keyboard) portions of generative AI session history 206 that are desired to be removed.

Selecting the portions of generative AI session history 206 may include: (i) highlighting a prompt, (ii) entering a command (e.g., to initiate a selection mode and/or to enter request 200), (iii) selecting a button on the GUI, and/or (iv) other actions.

Output B may be generated by feeding prompt A into generative AI model 202. An AI agent (e.g., a software program) may retrieve output B and may populate a chat window on the GUI using output B as part of the chat session.

Generative AI model 202 may be an LLM (e.g., a neural network inference model) trained to generate language, understand language, and/or otherwise process requests related to languages. Generative AI model 202 may have been previously trained using training data and any training process (e.g., a global optimization process using gradient descent), the training data indicating goals for outputs generated by generative AI model 202 (e.g., outputs). Parameters of generative AI model 202 may be selected using an optimization process (e.g., an objective function may be defined in terms of the training data and outputs generated by generative AI model 202, and a global optimization method such as gradient descent may be used to identify parameters that most faithfully reproduce the trends in the training data). Once the parameters of generative AI model 202 are set, then generative AI model 202 may be used to generate outputs (e.g., responses) based on input data (e.g., prompts). Generative AI model 202 may be trained using other methods without departing from embodiments disclosed herein.

To remove the portion of generative AI session history 206, temporary AI model modification process 204 may be performed. During temporary AI model modification process 204, modifications may be made to an internal state of generative AI model 202 to obtain temporarily updated generative AI model 210 (e.g., a modified instance of generative AI model 202).

Making modifications to the internal state of generative AI model 202 may include: (i) negating, based on request 200, embeddings corresponding to the portion of generative AI session history 206 that is desired to be removed to obtain temporarily updated generative AI model 210 (e.g., identifying the embeddings and zero masking the embeddings so they are ignored when processed), (ii) removing (e.g., deleting) tokens that correspond to the portion of generative AI session history 206 from a memory (e.g., attention) of generative AI model 202, (iii) adding, based on request 200, a negation layer to generative AI model 202 to obtain temporarily updated generative AI model 210, (iv) adding, based on request 200, a negation layer that feeds into an attention module of generative AI model 202 to obtain temporarily updated generative AI model 210, and/or (v) adding, based on request 200, a negation layer to a hidden layer of an attention module of generative AI model 202 to obtain temporarily updated generative AI model 210.

The negation layers may be placed so that information content corresponding to the portion of generative AI session history 206 that is desired to be removed (e.g., sequences of tokens similar to and/or the same as tokens of the portion of generative AI session history 206 that is desired to be removed) pass through the negation layers at different points in the architecture of temporarily updated generative AI model 210 (e.g., prior to or after the input layer, prior to the attention module, in a hidden layer of the attention module). Therefore, when the same and/or similar tokens pass through the negation layers, operations may be performed to modify the values of the tokens.

Temporarily updated generative AI model 210 may, therefore, include one or more of the above modifications thereby reducing an impact of the information content on future outputs generated by temporarily updated generative AI model 210.

Temporarily updated generative AI model 210 and generative AI session history 206 may be used to perform output generation process 212 to obtain output 214. During output generation process 212, generative AI session history 206 may be fed into temporarily updated generative AI model 210 to generate output 214 as output. However, temporarily updated generative AI model 210 may include one or more negations (e.g., negation layers, masked embeddings) so that information content of output B is removed from an internal state of temporarily updated generative AI model 210 and so that output B may have a reduced impact on output 214.

At the conclusion of the chat session, temporarily updated generative AI model 210 may be reverted to generative AI model 202 so that future chat sessions are not impacted by request 200. For example, any negation layers of temporarily updated generative AI model 210 may only impact tokens of the input that was desired to be removed from the generative AI session history and, consequently, the negation layers may not impact new input data (e.g., temporarily updated generative AI model 210 may not require active reversion to generative AI model 202). If any zero masking or manual deletion of portions of memory of generative AI model 202 was performed, a memory wipe may be performed to remove the zero masks and/or other memory modifications thereby reverting attention values and available contextual information of generative AI model 202 to an internal state prior to the temporary update.

Turning to FIG. 2B, a second data flow diagram in accordance with an embodiment is shown. The second data flow diagram may illustrate data used in and data processing performed in modifying a generative AI pipeline.

Throughout a duration of a generative AI session, a generative AI model may assign attention values to various portions of the generative AI session history (e.g., prompts and outputs). The attention values may impact a degree to which the generative AI model bases new outputs on each of the portions. In addition, attention values may change over time.

As a generative AI session progresses, the generative AI model may differentially utilize portions of the generative AI session history based on how recent the portions are (e.g., more recent portions may have more impact on new outputs and less recent portions may have less impact). Therefore, as a distance increases between a prompt and new portions of the generative AI session, an attention value for the prompt may decay until the prompt does not influence new outputs (e.g., the influence may be negligible).

As described in FIG. 2A during temporary AI model modification process 204, information may be added and/or removed from an internal state of generative AI model 202 to obtain temporarily updated generative AI model 210. While these processes occur, attention values for the portions of generative AI session history 206 may continue to decay. Therefore, during output generation process 212 described in FIG. 2A, attention values associated with portions of generative AI session history 206 may be lower than expected (e.g., may have less impact on generation of output 214 than if temporary AI model modification process 204 had not been performed).

This unintentional decay may reduce a quality and/or relevance of outputs generated by temporarily updated generative AI model 210 due to the portions of generative AI session history 206 being ascribed temporal attenuations (e.g., time and/or position delays) based on performance of processes such as temporary AI model modification process 204 instead of based on progression of the generative AI session as intended.

To increase a likelihood of providing desired computer-implemented services to downstream consumers (e.g., fulfilling requests such as request 200 during generative AI sessions), generative AI pipelines may be modified.

To modify a generative AI pipeline, generative AI pipeline modification process 218 may be performed. Generative AI pipeline 215 may include an instance of generative AI model 202 and any number of mechanisms (e.g., mechanism 216). Refer to the description of FIG. 2A for additional details regarding generative AI model 202.

Mechanism 216 may be a first mechanism of generative AI pipeline 215 and may effectively implement a decay counter for portions of the generative AI session history. As the entire generative AI session history (e.g., generative AI session history 206 described in FIG. 2A, analytic data and/or other internal values) may be used by generative AI model 202 when generating responses, the generative AI session history may be referred to as a prompt for the remainder of the description of FIG. 2B.

During generative AI pipeline modification process 218, at least mechanism 217 may be added to generative AI pipeline 215 to obtain modified generative AI pipeline 219.

Mechanism 217 may be a second mechanism of generative AI pipeline 215. Mechanism 217 may include any temporary modifications to fulfill request 200 (e.g., embedding masks, temporarily deleted tokens, negation layers, attention values). Refer to FIG. 2A for additional details regarding the temporary modifications.

Mechanism 216 may continue to operate while mechanism 217 is obtained, generated, and/or implemented in generative AI pipeline 215. Therefore, mechanism 216 may modify (e.g., reduce an impact of) attention values for portions of the prompt to an extent that exceeds an amount of decay prescribed by mechanism 216.

Turning to FIG. 2C, modifiers 211 may include modifiers (e.g., weights) ascribed to portions of the prompt (e.g., portions of generative AI session history 206) based on their relative temporal attenuations. As prompt A was added to the generative AI session history prior to output B, prompt A may have a lower weight (e.g., 0.88) when compared to a more recent portion (e.g., output B with a weight of 0.90). In this example, attention values for prompt A and output B may be multiplied by their modifiers during generation of the new output. Modifiers may include other information, may be represented in other ways, and may be implemented using other methods without departing from embodiments disclosed herein.

Modifiers 213 may include modifiers ascribed to prompt A and output B following performance of temporary AI model modification process 204. Modifiers 213 may be lower than modifiers 211 (e.g., prompt A may have a new modifier of 0.86 and output B may have a new modifier of 0.88). Therefore, prompt A and output B may have less impact on generation of a new portion of the chat session than intended (e.g., modifiers 211 may include the intended modifiers). Consequently, processes such as temporary AI model modification process 204 may unintentionally reduce a likelihood that the generative AI model produces outputs that meet needs of the downstream consumer.

Returning to FIG. 2B, the decay counter effectively implemented by mechanism 216 (e.g., an actual decay counter may not be used but the functionality of a decay counter may be performed) may define, at least in part, how different portions of the prompt are to be used in interpreting the different portions of the prompt (e.g., an extent to which one portion is used to interpret another portion). The decay counter, therefore, may indicate levels of importance of the different portions of the prompt in interpreting each of the portions of the prompt. The levels of importance may be based on temporal relations between the different portions of the prompt and each of the portions of the prompt.

For example, the levels of importance may be implemented using weights ascribed to each of the portions of the prompt while interpreting another portion of the prompt. For example, generative AI model 202 and mechanism 216 may interpret a most recent portion of the prompt (e.g., one or more characters of a most recent prompt provided by the downstream consumer) using all previous portions of the prompt. However, mechanism 216 may determine how each of the previous portions of the prompt impact interpretation of the most recent portion. Mechanism 216 may assign weights to each of the previous portions (e.g., based on an algorithm and/or rule set for weight assignment based on temporal attenuation) based on a distance (e.g., a temporal relation) between each of the previous portions and the most recent portion.

Consequently, a portion of the generative AI session history with a high degree of temporal attenuation with respect to the most recent portion (e.g., a portion that was added to the generative AI session history at the beginning of what has become a long chat session) may be assigned a weight so that the portion has little (e.g., negligible) impact on a new output generated by generative AI model 202.

Weights may be assigned using modifiers (e.g., an embedding and/or attention value for a portion may be multiplied by a modifier such as 0.01). Weights may be ascribed via other methods without departing from embodiments disclosed herein.

To increase a likelihood that outputs generated by generative AI pipeline 215 meet expectations of a downstream consumer, generative AI pipeline modification process 218 may be performed. During generative AI pipeline modification process 218, a modification may be made to generative AI pipeline 215 to obtain modified generative AI pipeline 219. The modification may include (i) temporarily pausing operation of mechanism 216 so that modifiers ascribed using mechanism 216 do not continue to decay and/or decay at a reduced rate, (ii) adding mechanism 217 to generative AI pipeline 215 (e.g., refer to temporary AI model modification process 204 described in FIG. 2A), (iii) resuming operation of mechanism 216 (e.g., reversing the pausing), and/or (iv) other methods.

Modified generative AI pipeline 219, therefore, may include: (i) generative AI model 202, (ii) mechanism 216, (iii) mechanism 217, and/or (iv) other data usable to generate outputs that meet expectations of downstream consumers.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, by implementing the data flows shown in FIGS. 2A-2C, a system in accordance with embodiments disclosed herein may be used to obtain requests (e.g., feedback) for removal of information content from a generative AI session history of a chat session. By modifying a generative AI pipeline based on the feedback, the chat session may continue with a reduced impact of the information content. Consequently, a reliability and/or usefulness of outputs may be increased for the downstream consumer.

Turning to FIG. 2D, an example graphical user interface (GUI) is shown. GUI 220 may display at least chat window 222 and text box 226. GUI 220 may be accessible by downstream consumers (e.g., via a website) and may include any number of pop-up interfaces, chat windows, buttons, graphics, and/or other elements through which information may be displayed to a viewer (e.g., a downstream consumer) and/or through which the viewer may interact. Other entities (e.g., an AI agent managing a chat service, a data processing system hosting the AI agent and/or any number of generative AI models) may populate GUI 220 with data intended to be displayed to the downstream consumer.

A downstream consumer may initiate a chat session with an AI agent (e.g., a computer program such as a chatbot) and chat window 222 and text box 226 may be displayed on GUI 220 to the downstream consumer for a duration of the chat session.

A customer may open chat window 222 and may enter prompt 223 into text box 226. Prompt 223 may include the following text: “I want some information about animals, but I am not interested in scientific classifications of animals.” Prompt 223 is shown next to a circle with the letter “A” inside the circle to indicate input from a first entity (e.g., the downstream consumer).

Prompt 223 may be used as ingest for a generative AI model and output 224 may be obtained as output from the generative AI model. The generative AI model (e.g., and/or an AI agent participating in the chat session) may provide output 224 as a response to prompt 223. Output 224 may include the following text: “Sure, I can help you with that. What kind of information are you looking for?” Output 224 is shown next to a circle with the letter “B” inside the circle to indicate input from a second entity (e.g., the AI agent).

The downstream consumer may continue the chat session by typing in additional prompts (e.g., prompt 225) to text box 226. Text box 226, for example, may include a prompt instructing the downstream consumer to “type a message or type “?” to select a prompt . . . ” The downstream consumer may provide prompts and/or commands via other types of interactions with GUI 220 without departing from embodiments disclosed herein.

Prompt 225 may include the text: “What do opossums, koalas, and sugar gliders have in common?” Output 227 may be generated based on the entire generative AI session history (e.g., at least prompt 223, output 224, and prompt 225). Output 227 may include the text: “Their offspring are called “joeys.””

Therefore, the downstream consumer may enter a special character or command (e.g., “?” is shown as an example in FIG. 2D) to enable functionality to select a portion of prompt 223 for removal from a generative AI session history of the chat session. Enabling selection information content for removal may be performed via other commands, other interactions, and/or other processes without departing from embodiments disclosed herein.

Turning to FIG. 2E, the downstream consumer may type in the command “?” in text box 226 to enable selection of a portion of prompt 223 (not shown). The downstream consumer may highlight, using a cursor on a display controlled by a human interface device such as a mouse, a portion of prompt 223.

For example, in FIG. 2E, the portion “, but I am not interested in scientific classifications of animals” has been highlighted on chat window 222 using a cursor. While shown with respect to highlighting a portion of prompt 223, portions of prompt 223 may be selected via other methods without departing from embodiments disclosed herein.

After selecting the text “, but I am not interested in scientific classifications of animals,” button 228 may appear next to the selected text. If the downstream consumer selects button 228, the information content related to the highlighted portion of prompt 223 may be removed from the generative AI session history of the chat session.

The generative AI model used to generate output 224 and output 227 may be temporarily modified so that outputs generated by the temporarily updated generative AI model are less influenced by the information content of “, but I am not interested in scientific classifications of animals” for the duration of the chat session (e.g., some latent influence may remain).

Turning to FIG. 2F, the removed information content of “, but I am not interested in scientific classifications of animals” may be shown in chat window 222 as crossed out to indicate that it has been removed from the generative AI session history.

Turning to FIG. 2G, a portion of the chat session that occurs after removal of the portion of prompt 223 may be shown. For example, the three filled in circles at the top of chat window 222 may indicate that other previous portions of the chat session are not shown (e.g., the downstream consumer may scroll up to view them).

Therefore, the downstream consumer may type in prompt 230 and output 232 may be generated by the temporarily updated generative AI model. Prompt 230 may include the text: “What do toads, frogs, and newts have in common?”

Output 232 may include the text: “Those animals belong to the class Amphibia, the phylum Chordata, the kingdom Animalia, and the domain Eukaryota.” Thus, the temporarily updated generative AI model may not have context available indicating that scientific classifications are not to be provided. In this example, a response from the generative AI model that includes a scientific classification of animals may be a “default” response from the generative AI model. If no modifying requests are made in a prompt, the response from the generative AI model may include scientific classifications. Therefore, the impact of the removed portion of prompt 223 may be reduced for future outputs generated during the chat session.

Thus, FIGS. 2D-2G show an example GUI and an example of a chat session between a downstream consumer and a backend system (e.g., an entity that hosts and/or operates generative AI models). It may be appreciated that the GUI may include other elements and information may be provided by the downstream consumer to the backend system via other methods without departing from embodiments disclosed herein.

As discussed above, the components of FIG. 1 may perform various methods to manage a data processing system. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of providing computer-implemented services using generative AI models in accordance with an embodiment is shown. The method may be performed, for example, by any of the components of the system of FIG. 1, and/or other components not shown therein.

At operation 300, a request to remove information content from a generative AI session history for a generative AI model may be obtained. Obtaining the request may include: (i) receiving the request as part of a chat session with a downstream consumer, (ii) reading the request from storage, (iii) receiving the request from another entity via a communication system, and/or (iv) other methods. The downstream consumer may enter the request via a GUI and using any number of human interface devices operably connected to a device operated by the downstream consumer.

At operation 302, the generative AI model may be temporarily modified, based on the request, to obtain a temporarily updated generative AI model. Temporarily modifying the generative AI model may include: (i) negating, based on the request, embeddings corresponding to the information content to obtain the temporarily updated generative AI model, (ii) adding, based on the request, a negation layer to the generative AI model to obtain the temporarily updated generative AI model, (iii) adding, based on the request, a negation layer that feeds into an attention module of the generative AI model to obtain the temporarily updated generative AI model, (iv) adding, based on the request, a negation layer to a hidden layer of an attention module of the generative AI model to obtain the temporarily updated generative AI model, and/or (v) other methods.

Negating the embeddings may include: (i) obtaining the embeddings corresponding to the information content (e.g., reading the embeddings from storage, obtaining the embeddings from another entity), (ii) zero masking the embeddings from (e.g., so that they are ignored when processed), and/or (iii) other methods.

Adding the negation layer to the generative AI model may include: (i) identifying elements (e.g., neurons) of an input layer of the generative AI model that consume the information content, (ii) performing an operation to modify a latent representation of the information content prior to or following ingestion by the neurons of the input layer, and/or (iii) other methods. Modifying the latent representation may include changing attention values of the input (e.g., multiplying the attention values by negative one). By doing so, the information content may be processed in a negated form (e.g., by the input layer, by a layer of neurons after the input layer).

Adding the negation layer (e.g., a layer that performs the modification of the information content) that feeds into the attention module may include methods similar to those described with respect to adding the negation layer to the input layer. However, the negation layer may be added to elements of the generative AI model that are located prior to an attention module of the generative AI model rather than in the input layer. Therefore, partially processed input data may pass through the negation layer prior to entering the attention module (e.g., attention layer) and/or after exiting the attention module.

Adding the negation layer to the hidden layer of the attention module may include methods similar to those described with respect to adding the negation layer to the input layer. However, the negation layer may be added within a hidden layer of the attention module rather than to the input layer. Therefore, partially processed input data may enter the attention module, pass through the negation layer at some point within the attention module, and may exit the attention module having passed through the negation layer.

At operation 304, an output may be obtained from the temporarily updated generative AI model and based on the generative AI session history. Obtaining the output may include: (i) feeding the chat history (e.g., the generative AI session history) into the generative AI model to obtain the output from an output layer of the generative AI model, (ii) providing the chat history to another entity responsible for operating the generative AI model, and/or (iii) other methods.

At operation 306, computer-implemented services may be provided to a downstream consumer using at least the output. Providing the computer-implemented services to the downstream consumer may include: (i) populating the GUI with at least the output (e.g., as part of a chat session), (ii) making decisions based on at least the output, (iii) providing the output to another entity, (iv) selecting one or more actions based on the output and performing the one or more actions to update operation of a system, and/or (v) other methods.

The method may end following operation 306.

After providing the computer-implemented services, an identification may be made that the generative AI session has ended. Making the identification that the generative AI session has ended may include obtaining feedback from a downstream consumer via the GUI (e.g., the downstream consumer may exit a chat window, the downstream consumer may close a website, the downstream consumer may enter a command initiating an end to the chat session.

After the chat session has ended, the temporarily updated generative AI model may be reverted to the generative AI model. Reverting the temporarily updated generative AI model to the generative AI model may include: (i) reversing a masking of embeddings corresponding to the information content, (ii) performing a memory wipe for the generative AI model (e.g., reversing modifications to attention values, tokens, and/or other internal representations of the generative AI model), (iii) and/or other methods.

Turning to FIG. 3B, a second flow diagram illustrating a method of providing computer-implemented services using generative AI models in accordance with an embodiment is shown. The method may be performed, for example, by any of the components of the system of FIG. 1, and/or other components not shown therein.

At operation 310, an identification may be made that a portion of a prompt for a generative AI model has been requested to be removed. Making the identification may include methods similar to those described with respect to obtaining the request in operation 300 of FIG. 3B (e.g., the request described in FIG. 3A may be a same request as a request through which the downstream consumer requested removal of the portion of the prompt).

Operations 312, 314, 316, 318, and 320 may be performed based on the identification made at operation 310.

At operation 312, operation of a first mechanism in a generative AI pipeline for the generative AI model may be temporarily modified to reduce an impact of the first mechanism and to obtain a first updated generative AI pipeline. Temporarily modifying the operation of the first mechanism may include: (i) pausing the decay counter (e.g., providing instructions to freeze weights, attention values, and/or other values ascribed by the decay counter to portions of the generative AI session history), (ii) reducing a rate of decay of the decay counter, (iii) otherwise modifying operation of the decay counter so that levels of importance (e.g., weights of an attention mechanism) ascribed to the portions of the prompt decay less while the operation of the first mechanism is temporarily modified, and/or (iv) other methods. Pausing the decay counter may also include providing instructions to another entity responsible for modifying the decay counter.

At operation 314, an un-inferencing process may be performed for the generative AI model while the first mechanism is temporarily modified to obtain a second updated generative AI pipeline. Performing the un-inferencing process may include methods similar to those described with respect to operation 302 in FIG. 3A.

At operation 316, the temporary modification to the operation of the first mechanism may be reversed to obtain a third updated generative AI pipeline. Reversing the temporary modification may include: (i) resuming the operation of the decay counter (e.g., providing instructions to un-freeze the weights, attention values, and/or other values ascribed to the portions of the generative AI session history), (ii) increasing the rate of decay of the decay counter to a rate of decay prior to the temporary modification, (iii) restoring the operation of the decay counter via other methods. Resuming the operation of the decay counter may also include providing instructions to another entity to modify (e.g., reverse the temporary modifications) to the operation of the decay counter. Therefore, the third updated generative AI pipeline may include the first mechanism, a second mechanism adapted to reduce an impact of the portion of the prompt that was requested to be removed, and the generative AI model.

At operation 318, the third updated generative AI pipeline may be used to generate a response to the prompt. Generating a response to the prompt using the third updated generative AI pipeline may include methods similar to those described with respect to operation 304 in FIG. 3A. For example, the prompt (e.g., the generative AI session history, any new prompts provided by the downstream consumer) may be fed into the third updated generative AI pipeline. By feeding the prompt into the updated generative AI pipeline, the first mechanism and the second mechanism may operate on the prompt at any point prior to, during, and/or after processing by the generative AI model instance.

At operation 320, computer-implemented services may be provided using the response. Providing the computer-implemented services may include methods similar to those described with respect to operation 306 in FIG. 3A.

The method may end following operation 320.

Thus, as illustrated above, embodiments disclosed herein may provide systems and methods usable to provide computer-implemented services using generative AI models. By temporarily modifying a generative AI model instance to remove an impact of a portion of a generative AI session history from a chat session, a likelihood of future outputs generated during the chat session meeting needs of the downstream consumer may be increased.

Any of the components illustrated in FIGS. 1-2G may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
making an identification that a portion of a prompt for a generative AI model of the generative AI models has been requested to be removed;
based on the identification:
temporarily modifying operation of a first mechanism in a generative AI pipeline for the generative AI model to reduce an impact of the first mechanism and to obtain a first updated generative AI pipeline, the first mechanism being adapted to effectively implement a decay counter for portions of the prompt;
performing, while the first mechanism is temporarily modified, an un-inferencing process for the generative AI model to obtain a second updated generative AI pipeline, the second updated generative AI pipeline being less impacted by the portion of the prompt than the first generative AI pipeline;
reversing the temporary modification to the operation of the first mechanism to obtain a third updated generative AI pipeline;
using the third updated generative AI pipeline to generate a response to the prompt; and
providing the computer-implemented services using the response.

2. The method of claim 1, wherein the decay counter defines, at least in part, how different portions of the prompt are to be used in interpreting the different portions of the prompt.

3. The method of claim 2, wherein the decay counter indicates levels of importance of the different portions of the prompt in interpreting each of the portions of the prompt.

4. The method of claim 3, wherein the levels of importance are based on temporal relations between the different portions of the prompt and each of the portions of the prompt.

5. The method of claim 1, wherein temporarily modifying the operation of the first mechanism comprises pausing the decay counter so that weights of an attention mechanism of the first updated generative AI pipeline decay less during performing the un-inferencing process.

6. The method of claim 1, wherein reversing the temporary modification to the operation of the first mechanism comprises resuming the decay counter.

7. The method of claim 1, wherein the generative AI pipeline comprises an inferencing engine based on the generative AI model, and the first mechanism.

8. The method of claim 1, wherein performing the un-inferencing process comprises at least one action selected from a list of actions consisting of:
negating embeddings corresponding to the portion of the prompt to obtain the second updated generative AI pipeline;
adding a negation layer to an input layer of the generative AI model to obtain the second updated generative AI pipeline;
adding the negation layer prior to an attention module of the generative AI model to obtain the second updated generative AI pipeline; and
adding the negation layer to a hidden layer of the attention module to obtain the second updated generative AI pipeline.

9. A non-transitory machine-readable medium having instructions stored therein, which when executed by a processor, cause the processor to perform operations for providing computer-implemented services using generative artificial intelligence (AI) models, the operations comprising:
making an identification that a portion of a prompt for a generative AI model of the generative AI models has been requested to be removed;
based on the identification:
temporarily modifying operation of a first mechanism in a generative AI pipeline for the generative AI model to reduce an impact of the first mechanism and to obtain a first updated generative AI pipeline, the first mechanism being adapted to effectively implement a decay counter for portions of the prompt;
performing, while the first mechanism is temporarily modified, an un-inferencing process for the generative AI model to obtain a second updated generative AI pipeline, the second updated generative AI pipeline being less impacted by the portion of the prompt than the first generative AI pipeline;
reversing the temporary modification to the operation of the first mechanism to obtain a third updated generative AI pipeline;
using the third updated generative AI pipeline to generate a response to the prompt; and
providing the computer-implemented services using the response.

10. The non-transitory machine-readable medium of claim 9, wherein the decay counter defines, at least in part, how different portions of the prompt are to be used in interpreting the different portions of the prompt.

11. The non-transitory machine-readable medium of claim 10, wherein the decay counter indicates levels of importance of the different portions of the prompt in interpreting each of the portions of the prompt.

12. The non-transitory machine-readable medium of claim 11, wherein the levels of importance are based on temporal relations between the different portions of the prompt and each of the portions of the prompt.

13. The non-transitory machine-readable medium of claim 9, wherein temporarily modifying the operation of the first mechanism comprises pausing the decay counter so that weights of an attention mechanism of the first updated generative AI pipeline decay less during performing the un-inferencing process.

14. The non-transitory machine-readable medium of claim 9, wherein reversing the temporary modification to the operation of the first mechanism comprises resuming the decay counter.

15. The non-transitory machine-readable medium of claim 9, wherein the generative AI pipeline comprises an inferencing engine based on the generative AI model, and the first mechanism.

16. A data processing system, comprising:
a processor; and
a memory coupled to the processor to store instructions, which when executed by the processor, cause the processor to perform operations for providing computer-implemented services using generative artificial intelligence (AI) models, the operations comprising:
making an identification that a portion of a prompt for a generative AI model of the generative AI models has been requested to be removed;
based on the identification:
temporarily modifying operation of a first mechanism in a generative AI pipeline for the generative AI model to reduce an impact of the first mechanism and to obtain a first updated generative AI pipeline, the first mechanism being adapted to effectively implement a decay counter for portions of the prompt;
performing, while the first mechanism is temporarily modified, an un-inferencing process for the generative AI model to obtain a second updated generative AI pipeline, the second updated generative AI pipeline being less impacted by the portion of the prompt than the first generative AI pipeline;
reversing the temporary modification to the operation of the first mechanism to obtain a third updated generative AI pipeline;
using the third updated generative AI pipeline to generate a response to the prompt; and
providing the computer-implemented services using the response.

17. The data processing system of claim 16, wherein the decay counter defines, at least in part, how different portions of the prompt are to be used in interpreting the different portions of the prompt.

18. The data processing system of claim 17, wherein the decay counter indicates levels of importance of the different portions of the prompt in interpreting each of the portions of the prompt.

19. The data processing system of claim 18, wherein the levels of importance are based on temporal relations between the different portions of the prompt and each of the portions of the prompt.

20. The data processing system of claim 16, wherein temporarily modifying the operation of the first mechanism comprises pausing the decay counter so that weights of an attention mechanism of the first updated generative AI pipeline decay less during performing the un-inferencing process.
